(19) United States
(12) Patent Application Publication
(10) Pub. No.: US 2017/0183500 A1
(43) Pub. Date: Jun. 29, 2017

(54) LOUDSPEAKER DIAPHRAGM

(71) Applicant: Onkyo Corporation, Osaka (JP)

(72) Inventors: Hiroyasu KUMO, Osaka (JP); Yushi ONO, Osaka (JP)

(21) Appl. No.: 15/341,054

(22) Filed: Nov. 2, 2016

(30) Foreign Application Priority Data
Dec. 24, 2015 (JP) 2015-251948

(51) Int. Cl. C08L 97/02; G10K 13/00

(52) U.S. Cl. CPC C08L 97/02; G10K 13/00

(57) ABSTRACT

A speaker diaphragm in which the Young's modulus, internal loss (tan δ), airtightness, and various strengths are well balanced is provided. The speaker diaphragm according to the present invention includes wood pulp and cellulose nanofibers, wherein, in one embodiment, the cellulose nanofibers are unoxidized cellulose nanofibers. The content rate of the cellulose nanofibers is one part by weight to 20 parts by weight with respect to 100 parts by weight of the wood pulp, for example.

### BACKGROUND OF THE INVENTION

1. Field of the Invention

The present invention relates to a speaker diaphragm.

2. Description of the Related Art

Generally, a speaker diaphragm is required to have characteristics such as high various strengths, high airtightness, high Young's modulus (modulus of elasticity; rigidity), and large internal loss (tan δ). To address such needs, studies have continuously been made regarding speaker diaphragm materials and structures. For example, JP-A-2013-42405 and JP-A-2011-130401 disclose speaker diaphragm materials and structures.

The present invention has been made to solve the problems of the related art, and an object of the present invention is to provide a speaker diaphragm in which the Young's modulus, internal loss (tan δ), airtightness, and various strengths are well balanced.

### SUMMARY OF THE INVENTION

The speaker diaphragm according to the present invention includes wood pulp and cellulose nanofibers, wherein the content rate of the cellulose nanofibers is one part by weight to 20 parts by weight with respect to 100 parts by weight of the wood pulp.

In one embodiment, the cellulose nanofibers may be unoxidized cellulose nanofibers.

According to the present invention, specific amounts of cellulose nanofibers are incorporated, whereby a speaker diaphragm in which the Young's modulus, internal loss (tan δ), airtightness, and various strengths are well balanced can be provided.

### BRIEF DESCRIPTION OF THE DRAWINGS

FIG. 1 is a diagram illustrating the speaker diaphragm frequency characteristics obtained in the fifteenth embodiment, the sixteenth embodiment, and the eighth comparative example;

FIG. 2 is a diagram illustrating the speaker diaphragm frequency characteristics obtained in the seventeenth embodiment, the eighteenth embodiment, and the eighth comparative example; and

FIG. 3 is a diagram illustrating the speaker diaphragm frequency characteristics obtained in the nineteenth embodiment, the twentieth embodiment, and the ninth comparative example.

### DETAILED DESCRIPTION OF THE PREFERRED EMBODIMENTS

The speaker diaphragm according to an embodiment of the present invention includes wood pulp and cellulose nanofibers. The speaker diaphragm can be obtained by blending and mixing cellulose nanofibers with wood pulp. By blending cellulose nanofibers, a speaker diaphragm with a structure which is dense and in which the fibers are strongly bound together can be obtained, whereby a speaker diaphragm having high Young's modulus can be obtained. In addition, in the speaker diaphragm according to the present invention, density, airtightness, strength and the like can be adjusted in a balanced manner. The speaker diaphragm according to the present invention has a wide high-frequency reproduction band, and can provide excellent sound quality.

The cellulose nanofibers refer to cellulose fibers with a nano-sized fiber diameter. The cellulose nanofibers have a fiber diameter (number average diameter) of 3 nm to 100 nm, for example. The cellulose nanofibers have a length (number average length) of 0.1 μm to 100 μm, for example. The cellulose nanofibers have an aspect ratio (length/diameter) of 50 to 1000, for example. The pulp normally has a fiber diameter of not less than 1 μm. In the present specification, cellulose nanofibers and pulp are distinguished by their fiber diameters.

Examples of the method for manufacturing cellulose nanofibers include an aqueous counter collision process (ACC process) where suspensions of pulp dispersed in water are collided with each other to fibrillate and achieve size reduction, and a method that fibrillates cellulose raw material by a mechanical process. Examples of the mechanical process for size reduction of cellulose raw material include the use of a low-pressure homogenizer; a high-pressure homogenizer; a grinder; a cutter mill; a jet mill; a single-screw extruder; a twin-screw extruder; and an ultrasonic stirrer. It is also possible to manufacture cellulose nanofibers by fibrillating cellulose raw material by a chemical process, such as oxygen process and acid process. However, in the present invention, it is preferable to use unoxidized cellulose nanofibers obtained by the aqueous counter collision process (ACC process), a mechanical process, or the like. Use of the unoxidized cellulose nanofibers enables fabrication of a speaker diaphragm in which the Young's modulus, internal loss (tan δ), airtightness, and various strengths are well balanced.

The cellulose raw material is not particularly limited, and any appropriate cellulose raw material may be used. Examples of the cellulose raw material include wood-derived kraft pulps, such as leaf bleached kraft pulp (LBKP), leaf unbleached kraft pulp (LUKP), hardwood kraft pulp (LKP), needle bleached kraft pulp (NBKP), and needle unbleached kraft pulp (NUKP); waste paper pulp such as sulfite pulp and deinked pulp (DIP); ground pulp (GP); and mechanical pulp such as pressure ground wood pulp (PGW), refiner mechanical pulp (RMP), thermomechanical pulp (TMP), chemical thermomechanical pulp (CTMP), chemical mechanical pulp (CMP), and chemical ground pulp (CGP). These pulps may be pulverized to obtain powdered cellulose or pulp, which may then be refined by a chemical process such as acid hydrolysis, obtaining microcrystalline cellulose for use. In addition, non-wood pulp derived from kenaf, hemp, rice, bagasse, reed, bamboo, cotton and the like maybe used. In one embodiment, softwood-derived cellulose is used as the raw material for cellulose nanofibers. Use of the softwood-derived cellulose makes it possible to obtain a speaker diaphragm having an increased Young's modulus.

The content rate of the cellulose nanofibers is preferably one part by weight to 20 parts by weight, more preferably three parts by weight to 15 parts by weight, and even more preferably five parts by weight to 10 parts by weight with respect to 100 parts by weight of the wood pulp. When in such ranges, a speaker diaphragm in which the Young's modulus, internal loss (tan δ), airtightness, and various strengths are well balanced can be obtained. If the content rate of the cellulose nanofibers exceeds 20 wt %, the speaker diaphragm becomes thinner as the density is increased, possibly adversely affecting the balance of the physical characteristics of the speaker diaphragm. In addition, if the content rate of the cellulose nanofibers exceeds 20 wt %, the speaker diaphragm will take longer to make, possibly resulting in a significant decrease in manufacturing efficiency.

The wood pulp is not particularly limited, and wood pulps normally used for speaker diaphragms may be adopted. For example, softwood pulp, hardwood pulp and the like are used.

The degree of beating of the wood pulp is preferably 150 cc to 700 cc and more preferably 200 cc to 600 cc. When in such ranges, a speaker diaphragm having a high internal loss (tan δ) can be obtained. The beating degree is measured in accordance with JIS P 8121.

The speaker diaphragm may additionally contain other fibers as needed. The other fibers may be selected as appropriate in accordance with the purpose. For example, if the purpose is to increase mechanical strength, high-strength fiber may be mixed. In addition, a fiber for a particular purpose (such as deodorant fiber or minus ion-releasing fiber) may be mixed.

The speaker diaphragm has a density of preferably not less than 0.3 g/cc and more preferably not less than 0.4 g/cc. When in such ranges, a speaker diaphragm which is particularly excellent in Young's modulus can be obtained.

The speaker diaphragm has a folding endurance of preferably 1000 times or more, more preferably 2000 times or more, and even more preferably 2500 times or more. A method for measuring folding endurance will be described later.

The speaker diaphragm has a stiffness of preferably 1000 mgf to 5000 mgf, and more preferably 1500 mgf to 3000 mgf. When in such ranges, a speaker diaphragm which is particularly excellent in Young's modulus can be obtained. A method for measuring stiffness will be described later.

The speaker diaphragm has a tearing strength of preferably not less than 200 gf, and more preferably not less than 300 gf. A method for measuring tearing strength will be described later.

The speaker diaphragm has an airtightness of preferably not less than 5 s/100cc, more preferably not less than 10 s/100 cc, and even more preferably not less than 15 s/100 cc. A method for measuring airtightness will be described later.

The speaker diaphragm according to the present invention may be manufactured by any appropriate manufacturing method. A representative manufacturing method includes blending and mixing a predetermined amount of cellulose nanofibers to wood pulp as a principal component; and forming a flat plate obtained by the mixing to a predetermined shape. As the methods for mixing and forming, any appropriate methods maybe adopted. An example of the forming method is hot-press forming.

The speaker diaphragm according to the present invention may have any appropriate shape in accordance with the purpose. The speaker diaphragm according to the present invention may have a cone shape, a dome shape, or other shapes, for example.

The speaker diaphragm according to the present invention may be used in speakers for any use. For example, a speaker using the diaphragm of the present invention may be for mounting on a vehicle, for a portable electronic device (such as a portable telephone or portable music player), or for fixed installation. The speaker using the diaphragm of the present invention may have a large diameter, an intermediate diameter, or a small diameter. Preferably, the diaphragm of the present invention may be used for a small-diameter speaker.

### Embodiments

In the following, the present invention will be described in more concrete terms with reference to embodiments. However, the present invention is not limited to the embodiments. In the embodiments, evaluation methods are as follows. Unless otherwise specifically indicated, the parts and percentages in the embodiments are with reference to weight.

### <Evaluation>

1. Measurement of Young's modulus and internal loss (tan δ)

The Young's modulus and internal loss (tan δ) of the obtained speaker diaphragm were measured by the vibrating reed method (cantilever, resonance method). Specifically, from each of flat plates obtained in the embodiments and comparative examples, five test pieces of a size of 40 mm×15 mm were cut out, and the Young's modulus and internal loss (tan δ) of each test piece were measured at 23° C. In the table, average values of the five test pieces are shown.
2. Density

From each of the flat plates obtained in the embodiments and comparative examples, five test pieces of a size of 40 mm×15 mm were cut out. The thickness and weight of each test piece were measured at four points (i.e., 4 points×5 test pieces for a total of 20 points) using a dial thickness gauge, and an average density value was determined from the measured values.
3. Folding endurance

From each of the flat plates obtained in the embodiments and comparative examples, five test pieces of a size of 40 mm×110 mm were cut out and measured in accordance with JIS P 8115. The average values are shown in the table.
4. Stiffness

From each of the flat plates obtained in the embodiments and comparative examples, five test pieces of a size of 35 mm×70 mm were cut out and measured in accordance with JIS P 8125. The average values are shown in the table.
5. Tearing strength

From each of the flat plates obtained in the embodiments and comparative examples, five test pieces of a size of 63 mm×76 mm were cut out and measured in accordance with JIS P 8116. The average values are shown in the table.
6. Airtightness

From each of the flat plates obtained in the embodiments and comparative examples, five test pieces of a size of 50 mm×50 mm were cut out and measured in accordance with JIS P 8117. The average values are shown in the table.

### First Embodiment

To 100 parts of UKP (beating degree 500 cc), one part of softwood-derived cellulose nanofibers (manufactured by Chuetsu Pulp & Paper Co., Ltd., with a fiber diameter of approximately 20 nm) was blended and mixed, and a flat plate with a weight of approximately 150 g/m² was obtained by an oven system. The obtained flat plate was subjected to the above evaluations 1 to 6. The results are shown in Table 1.

### Second Embodiment

A flat plate was obtained in the same way as in the first embodiment with the exception that the blended amount of the cellulose nanofibers was five parts. The obtained flat plate was subjected to the above evaluations 1 to 6. The results are shown in Table 1.

### Third Embodiment

A flat plate was obtained in the same way as in the first embodiment with the exception that the blended amount of the cellulose nanofibers was 10 parts. The obtained flat plate was subjected to the above evaluations 1 to 6. The results are shown in Table 1.

### Fourth Embodiment

A flat plate was obtained in the same way as in the first embodiment with the exception that, instead of the softwood-derived cellulose nanofibers, bamboo-derived cellulose nanofibers (manufactured by Chuetsu Pulp & Paper Co., Ltd., with a fiber diameter of approximately 20 nm) were used. The obtained flat plate was subjected to the above evaluations 1 to 6. The results are shown in Table 1.

### Fifth Embodiment

A flat plate was obtained in the same way as in the fourth embodiment with the exception that the blended amount of the cellulose nanofibers was five parts. The obtained flat plate was subjected to the above evaluations 1 to 6. The results are shown in Table 1.

### Sixth Embodiment

A flat plate was obtained in the same way as in the fourth embodiment with the exception that the blended amount of the cellulose nanofibers was 10 parts. The obtained flat plate was subjected to the above evaluations 1 to 6. The results are shown in Table 1.

### Seventh Embodiment

To 100 parts of a mixed wood pulp (beating degree 550 cc) of 70 parts of SP and 30 parts of BKP, one part of softwood-derived cellulose nanofibers (manufactured by Chuetsu Pulp & Paper Co., Ltd., with a fiber diameter of approximately 20 nm) was blended and mixed, and a flat plate with a weight of approximately 150 g/m² was obtained using a press system. The obtained flat plate was subjected to the above evaluations 1 to 6. The results are shown in Table 1.

### Eighth Embodiment

A flat plate was obtained in the same way as in the seventh embodiment with the exception that the blended amount of the cellulose nanofibers was five parts. The obtained flat plate was subjected to the above evaluations 1 to 6. The results are shown in Table 1.

### Ninth Embodiment

A flat plate was obtained in the same way as in the seventh embodiment with the exception that the blended amount of the cellulose nanofibers was 10 parts. The obtained flat plate was subjected to the above evaluations 1 to 6. The results are shown in Table 1.

### Tenth Embodiment

A flat plate was obtained in the same way as in the seventh embodiment with the exception that, instead of the softwood-derived cellulose nanofibers, bamboo-derived cellulose nanofibers (manufactured by Chuetsu Pulp & Paper Co., Ltd., with a fiber diameter of approximately 20 nm) were used. The obtained flat plate was subjected to the above evaluations 1 to 6. The results are shown in Table 1.

### Eleventh Embodiment

A flat plate was obtained in the same way as in the tenth embodiment with the exception that the blended amount of the cellulose nanofibers was five parts. The obtained flat plate was subjected to the above evaluations 1 to 6. The results are shown in Table 1.

### Twelfth Embodiment

A flat plate was obtained in the same way as in the tenth embodiment with the exception that the blended amount of the cellulose nanofibers was 10 parts. The obtained flat plate was subjected to the above evaluations 1 to 6. The results are shown in Table 1.

### Thirteenth Embodiment

To 100 parts of UKP (beating degree 700 cc), five parts of softwood-derived cellulose nanofibers (manufactured by Chuetsu Pulp & Paper Co., Ltd., with a fiber diameter of approximately 20 nm) were blended and mixed, and a flat plate with a weight of approximately 150 g/m² was obtained by an oven system. The obtained flat plate was subjected to the above evaluations 1 to 6. The results are shown in Table 1.

### Fourteenth Embodiment

A flat plate was obtained in the same way as in the thirteenth embodiment with the exception that the blended amount of the cellulose nanofibers was 10 parts. The obtained flat plate was subjected to the above evaluations 1 to 6. The results are shown in Table 1.

### Fifteenth Embodiment

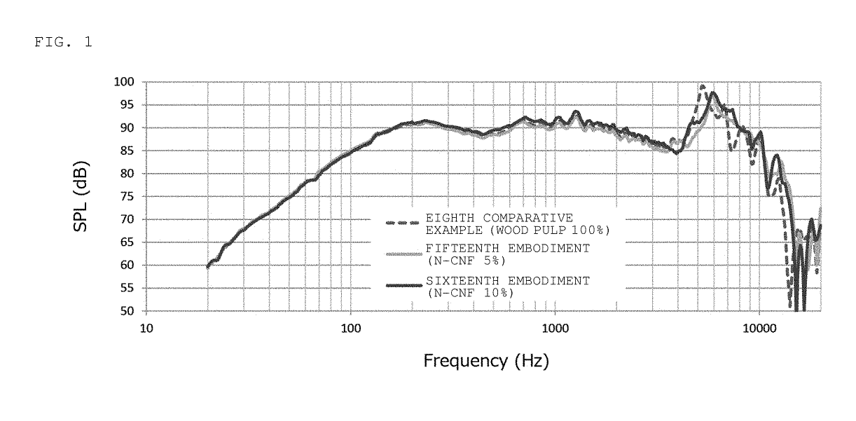

The blend according to the second embodiment was mixed to fabricate an oven cone with a diameter of 15 cm. With respect to the cone, frequency characteristics were measured, and sound quality was evaluated. The results are illustrated in FIG. 1.

### Sixteenth Embodiment

The blend according to the third embodiment was mixed to fabricate an oven cone with a diameter of 15 cm. With respect to the cone, frequency characteristics were measured, and sound quality was evaluated. The results are illustrated in FIG. 1.

### Seventeenth Embodiment

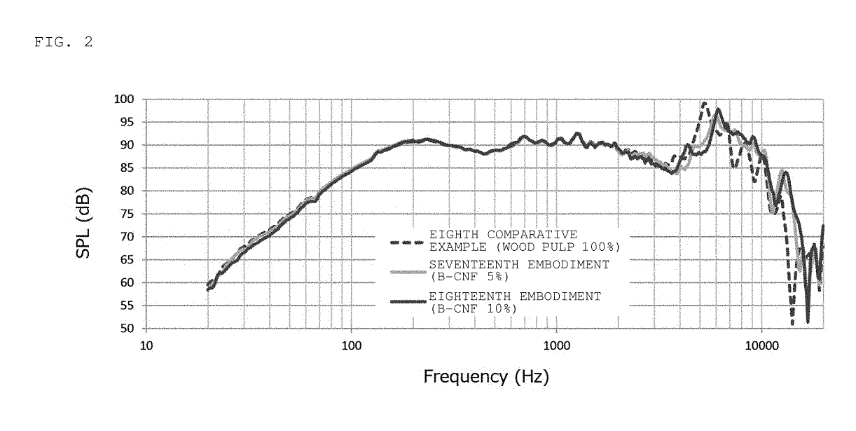

The blend according to the fifth embodiment was mixed to fabricate an oven cone with a diameter of 15 cm. With respect to the cone, frequency characteristics were measured, and sound quality was evaluated. The results are illustrated in FIG. 2.

### Eighteenth Embodiment

The blend according to the sixth embodiment mixed to fabricate an oven cone with a diameter of 15 cm. With respect to the cone, frequency characteristics were measured, and sound quality was evaluated. The results are illustrated in FIG. 2.

### Nineteenth Embodiment

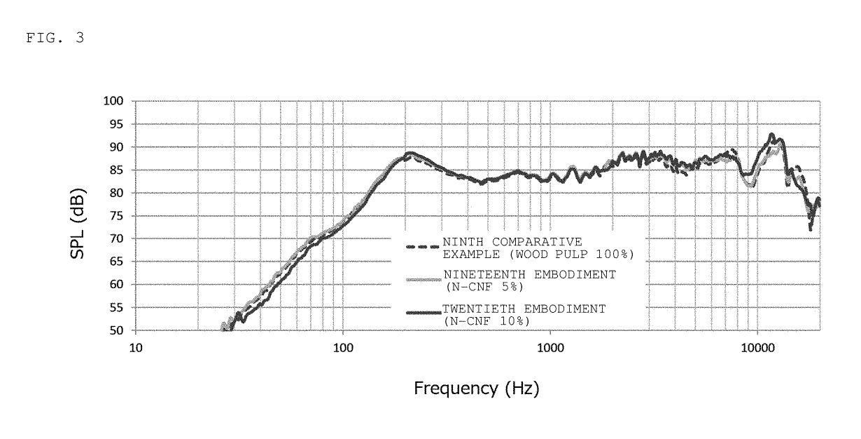

The blend according to the eighth embodiment was mixed to fabricate an oven cone with a diameter of 7 cm. With respect to the cone, frequency characteristics were measured, and sound quality was evaluated. The results are illustrated in FIG. 3.

### Twentieth Embodiment

The blend according to the ninth embodiment was mixed to fabricate an oven cone with a diameter of 7 cm. With respect to the cone, frequency characteristics were measured, and sound quality was evaluated. The results are illustrated in FIG. 3.

### First Comparative Example

A flat plate was obtained in the same way as in the first embodiment with the exception that cellulose nanofibers were not blended. The obtained flat plate was subjected to the above evaluations 1 to 6. The results are shown in Table 1.

### Second Comparative Example

A flat plate was obtained in the same way as in the seventh embodiment with the exception that cellulose nanofibers were not blended. The obtained flat plate was subjected to the above evaluations 1 to 6. The results are shown in Table 1.

### Third Comparative Example

A flat plate was obtained in the same way as in the thirteenth embodiment with the exception that cellulose nanofibers were not blended. The obtained flat plate was subjected to the above evaluations 1 to 6. The results are shown in Table 1.

### Fourth Comparative Example

A flat plate was obtained in the same way as in the thirteenth embodiment with the exception that, instead of five parts of softwood-derived cellulose nanofibers, five parts of microfibril cellulose (manufactured by Daicel Corporation, trade name “Celish KY100G”, with a fiber diameter of approximately 200 nm) were used. The obtained flat plate was subjected to the above evaluations 1 to 6. The results are shown in Table 1.

### Fifth Comparative Example

A flat plate was obtained in the same way as in the thirteenth embodiment with the exception that, instead of five parts of softwood-derived cellulose nanofibers, 10 parts of microfibril cellulose (manufactured by Daicel Corporation, trade name “Celish KY100G”, with a fiber diameter of approximately 200 nm) were used. The obtained flat plate was subjected to the above evaluations 1 to 6. The results are shown in Table 1.

### Sixth Comparative Example

A flat plate was obtained in the same way as in the thirteenth embodiment with the exception that, instead of five parts of softwood-derived cellulose nanofibers, five parts of microfibril cellulose (manufactured by Daicel Corporation, trade name “Celish KY110N”, with a fiber diameter of approximately 200 nm) were used. The obtained flat plate was subjected to the above evaluations 1 to 6. The results are shown in Table 1.

### Seventh Comparative Example

A flat plate was obtained in the same way as in the thirteenth embodiment with the exception that, instead of five parts of softwood-derived cellulose nanofibers, 10 parts of microfibril cellulose (manufactured by Daicel Corporation, trade name “Celish KY110N”, with a fiber diameter of approximately 200 nm) were used. The obtained flat plate was subjected to the above evaluations 1 to 6. The results are shown in Table 1.

### Eighth Comparative Example

An oven cone with a diameter of 15 cm was fabricated using the flat plate obtained in the first comparative example. With respect to the cone, frequency characteristics were measured, and sound quality was evaluated. The results are illustrated in FIG. 1 and FIG. 2.

### Ninth Comparative Example

An oven cone with a diameter of 7 cm was fabricated using the flat plate obtained in the second comparative example. With respect to the cone, frequency characteristics were measured, and sound quality was evaluated. The results are illustrated in FIG. 3.

TABLE 1

| | | | CNF Content | | Thick- | Folding | Stiff- | Tearing | | | |
|---|---|---|---|---|---|---|---|---|---|---|---|
| | Wood | | Rate | Density | ness | Endurance | ness | Strength | Airtightness | E | |
| | Pulp | CNF | (%) | (g/cc) | (mm) | (times) | (mgf) | (gf) | (s/100 cc) | (dyn/cm²) | tanδ |
| First Comparative | UPK500 | — | 0 | 0.385 | 0.382 | 2219 | 2987 | 275 | 4.5 | 1.18 * 10¹⁰ | 0.0379 |
| Example | | | | | | | | | | | |
| First Embodiment | | Softwood | 1 | 0.391 | 0.38 | 1541 | 2520 | 320 | 4.9 | 1.18 * 10¹⁰ | 0.0376 |
| Second Embodiment | | | 5 | 0.449 | 0.338 | 2637 | 2473 | 304 | 19.2 | 1.54 * 10¹⁰ | 0.0373 |
| Third Embodiment | | | 10 | 0.538 | 0.271 | 2561 | 1563 | 341 | 83.4 | 2.26 * 10¹⁰ | 0.0369 |
| Fourth Embodiment | | Bamboo | 1 | 0.393 | 0.38 | 3136 | 3477 | 357 | 5.9 | 1.14 *10¹⁰ | 0.0377 |
| Fifth Embodiment | | | 5 | 0.438 | 0.337 | 3537 | 1913 | 328 | 18 | 1.53 * 10¹⁰ | 0.0375 |
| Sixth Embodiment | | | 10 | 0.505 | 0.283 | 2362 | 1610 | 301 | 71.6 | 2.18 * 10¹⁰ | 0.0337 |
| Second Comparative | SP/BKP | — | 0 | 0.369 | 0.385 | 34 | 1610 | 152 | 2.1 | 1.01 * 10¹⁰ | 0.0395 |
| Example | | | | | | | | | | | |
| Seventh | | Softwood | 1 | 0.397 | 0.366 | 79 | 1843 | 176 | 4 | 1.33 *10¹⁰ | 0.0391 |
| Embodiment | | | | | | | | | | | |
| Eighth Embodiment | | | 5 | 0.436 | 0.335 | 329 | 1843 | 240 | 12.6 | 1.57 * 10¹⁰ | 0.0367 |
| Ninth Embodiment | | | 10 | 0.496 | 0.281 | 278 | 1307 | 179 | 47.5 | 1.81 * 10¹⁰ | 0.0361 |
| Tenth Embodiment | | Bamboo | 1 | 0.397 | 0.373 | 70 | 2077 | 192 | 4.6 | 1.22 * 10¹⁰ | 0.0392 |
| Eleventh | | | 5 | 0.434 | 0.332 | 251 | 1843 | 184 | 12 | 1.64 * 10¹⁰ | 0.0387 |
| Embodiment | | | | | | | | | | | |
| Twelfth | | | 10 | 0.491 | 0.281 | 522 | 1097 | 149 | 40 | 1.76 * 10¹⁰ | 0.0367 |
| Embodiment | | | | | | | | | | | |
| Third Comparative | UPK700 | — | 0 | 0.239 | 0.634 | 61 | 4562 | 203 | 0.6 | 3.12 * 10⁹ | 0.041 |
| Example | | | | | | | | | | | |
| Thirteenth | | Softwood | 5 | 0.287 | 0.532 | 728 | 4090 | 239 | 1.7 | 6.36 * 10⁹ | 0.0347 |
| Embodiment | | | | | | | | | | | |
| Fourteenth | | | 10 | 0.358 | 0.428 | 1160 | 3250 | 311 | 9.8 | 8.30 * 10⁹ | 0.0348 |
| Embodiment | | | | | | | | | | | |
| Fourth Comparative | | — | 0 | 0.286 | 0.533 | 399 | 4290 | 219 | 1.5 | 5.44 * 10⁹ | 0.0364 |
| Example | | | (KY100G 5%) | | | | | | | | |
| Fifth Comparative | | — | 0 | 0.336 | 0.449 | 925 | 3760 | 301 | 5.5 | 7.90 * 10⁹ | 0.0326 |
| Example | | | (KY100G 10%) | | | | | | | | |
| Sixth Comparative | | — | 0 | 0.303 | 0.499 | 199 | 3757 | 256 | 1.4 | 5.67 * 10⁹ | 0.0358 |
| Example | | | (KY110N 5%) | | | | | | | | |
| Seventh | | — | 0 | 0.334 | 0.453 | 1118 | 4223 | 261 | 5.9 | 8.16 * 10⁹ | 0.0338 |
| Comparative | | | (KY110N 10%) | | | | | | | | |
| Example | | | | | | | | | | | |

As will be seen from Table 1, in the speaker diaphragm according to the present invention, the Young's modulus, internal loss (tan δ), airtightness, and various strengths are well balanced on account of the incorporation of specific amounts of cellulose nanofibers. In addition, as will be seen from FIGS. 1 to 3, the speaker diaphragm according to the present invention has a wide high-frequency reproduction band, and can provide excellent sound quality.

The speaker diaphragm according to the present invention can be suitably used in speakers for any purposes.

What is claimed is:

1. A speaker diaphragm comprising a wood pulp and cellulose nanofibers,
wherein a content rate of the cellulose nanofibers is one part by weight to 20 parts by weight with respect to 100 parts by weight of the wood pulp.

2. The speaker diaphragm according to claim 1, wherein the cellulose nanofibers are unoxidized cellulose nanofibers.
